(19) United States
(12) Patent Application Publication
(10) Pub. No.: US 2024/0255084 A1
(43) Pub. Date: Aug. 1, 2024

(54) 3-PIECE COMPRESSION COUPLING FOR ELECTRICAL METALLIC TUBING

(71) Applicant: Eaton Intelligent Power Limited, Dublin (IE)

(72) Inventors: Harshad Nitin KESKAR, Maharashtra (IN); Martin L. WITHERBEE, Godfrey, IL (US)

(21) Appl. No.: 18/423,953

(22) Filed: Jan. 26, 2024

(30) Foreign Application Priority Data
Jan. 31, 2023 (IN) 202311006104

(51) Int. Cl. F16L 37/091

(52) U.S. Cl. CPC F16L 37/0915

(57) ABSTRACT

A compression coupling assembly for joining at least one conduit. The compression coupling assembly includes a coupling body and a compression nut. The coupling body has an end portion and a central portion. The end portion has a threaded portion on an outer surface of the coupling body. The coupling body includes a plurality of spaced-apart teeth extending away from the threaded portion and the central portion. The compression nut includes an inner thread and a protrusion. The inner thread is configured to engage with the threaded portion of the coupling body. The protrusion has a leading surface that is configured to engage with the plurality of spaced-apart teeth. The plurality of spaced-apart teeth is configured to compress an outer surface of a conduit.

### CROSS REFERENCE TO RELATED APPLICATIONS

This application claims benefit of and priority to Indian Patent Application No. 202311006104, filed Jan. 31, 2023, entitled “3-PIECE COMPRESSION COUPLING FOR ELECTRICAL METALLIC TUBING,” which is incorporated herein in its entirety.

### FIELD

The subject application relates to couplings for cables. More particularly, a compression coupling assembly that includes three components.

### BACKGROUND

Compression couplings find particular application in joining two conduits together or joining a single conduit to an electrical panel. The compression coupling exerts a compression force to an outer surface of the conduits to maintain the conduits in a desired position relative to each other or to an outer surface of a single conduit to maintain it in a desired position relative to the electrical panel.

There is a need for a compression coupling with fewer parts that provides for repeatable and reliable coupling of two conduits together or coupling of one conduit to an electrical panel.

The present invention provides a compression coupling assembly that allows a user the ability to quickly and easily couple two conduits to each other or to couple a single conduit to an electrical panel.

### SUMMARY OF THE INVENTION

There is provided a compression coupling assembly for joining at least one conduit. The compression coupling assembly includes a coupling body having an end portion and a central portion, and a compression nut. The end portion of the coupling body has a threaded portion on an outer surface of the coupling body. A plurality of spaced-apart teeth extend axially away from the threaded portion and the central portion. The compression nut has an inner thread and a protrusion. The inner thread engages with the threaded portion of the coupling body. The protrusion has a leading surface that is configured to engage with the plurality of spaced-apart teeth. The plurality of spaced-apart teeth compress an outer surface of a conduit.

In the foregoing compression coupling assembly, the coupling body may have a second end portion located opposite the other end portion.

In the foregoing compression coupling assembly, the second end portion has a second threaded portion on the outer surface of the coupling body. The second end portion also has a plurality of spaced-apart teeth extending away from the second threaded portion and the central portion of the coupling body.

In the foregoing compression coupling assembly, the coupling assembly includes a second compression nut. The second compression nut has an inner thread and a protrusion. The second compression nut engages the second threaded portion of the coupling body.

In the foregoing compression coupling assembly, the coupling body is attached to an electrical panel. In the foregoing compression coupling assembly, the coupling body and the compression nut extend along a longitudinal axis.

In the foregoing compression coupling assembly, the plurality of spaced-apart teeth extend axially away from the threaded portion and the central portion.

In the foregoing compression coupling assembly, an outer surface of the compression nut includes a plurality of flats formed therein.

In the foregoing compression coupling assembly, the plurality of flats are formed within the central portion of the outer surface of the compression nut.

In the foregoing compression coupling assembly, at least one stop protrudes radially inward.

In the foregoing compression coupling assembly, the at least one stop is configured to engage with the at least one conduit.

In the foregoing compression coupling assembly, the compression nut further includes an inwardly sloped flange and a trailing surface.

In the foregoing compression coupling assembly, the trailing surface is located between the inwardly sloped flange and the protrusion.

In the foregoing compression coupling assembly, the inwardly sloped flange forms a boundary for an opening.

### BRIEF DESCRIPTION OF THE DRAWINGS

FIG. 1 is a perspective view of an assembled compression coupling assembly;

FIG. 2 is an exploded view of the compression coupling assembly of FIG. 1;

FIG. 3 is a sectional view of a first compression nut of the compression coupling assembly of FIG. 2 taken along line 3-3;

FIG. 4 is a sectional view of a second compression nut of the compression coupling assembly of FIG. 2 taken along line 4-4;

FIG. 5A is a first perspective view of a coupling body of the compression coupling assembly of FIG. 2;

FIG. 5B is a second perspective view of a coupling body of the compression coupling assembly of FIG. 2;

FIG. 5C is sectional view of the coupling body of FIG. 2 taken along line 5-5;

FIG. 5D is a sectional view of the coupling body of the compression coupling assembly of FIG. 5C taken along line 5D-5D;

FIG. 6 is a sectional view of the compression coupling assembly of FIG. 1 taken along line 6-6;

FIG. 7A is a sectional view of the compression coupling assembly of FIG. 1 taken along line 6-6, illustrating the compression coupling assembly attached to a first conduit and a second conduit wherein the first conduit and the second conduit are in a first position;

FIG. 7B is a sectional view of the compression coupling assembly of FIG. 1 taken along line 6-6, illustrating the compression coupling assembly attached to a first conduit and a second conduit wherein the first conduit and the second conduit are in a second position; and

FIG. 8 is a sectional view of the compression coupling assembly of FIG. 1 taken along line 6-6, illustrating the compression coupling assembly connecting a single conduit to an electrical panel.

### DETAILED DESCRIPTION

The following presents a description of the disclosure; however, aspects may be embodied in many different forms and should not be construed as limited to the embodiments set forth herein. Furthermore, the following examples may be provided alone or in combination with one or any combination of the examples discussed herein.

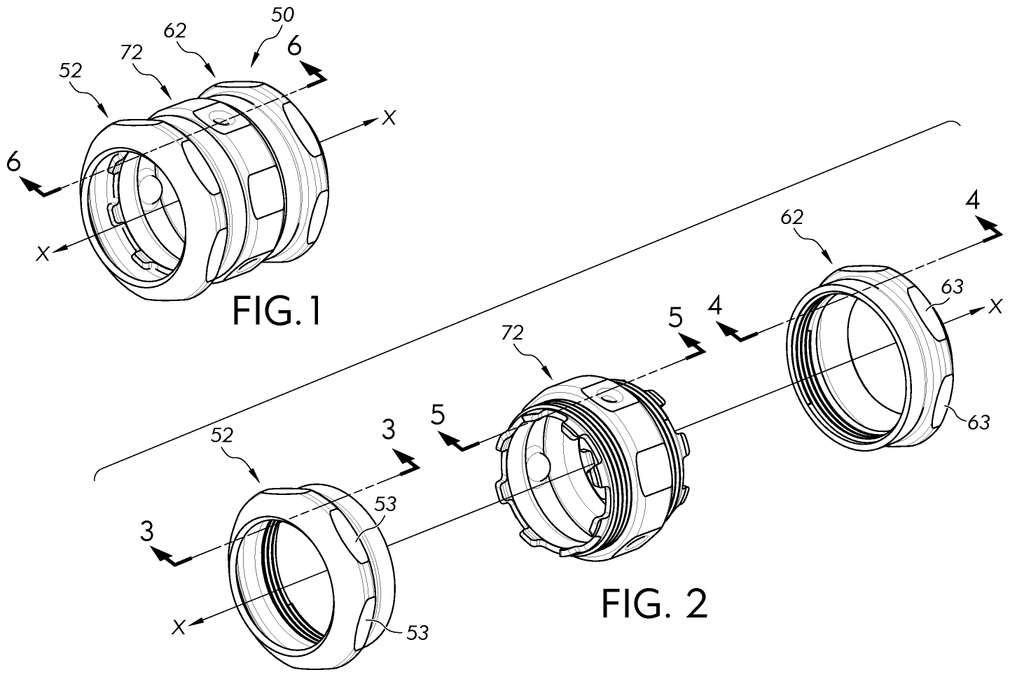

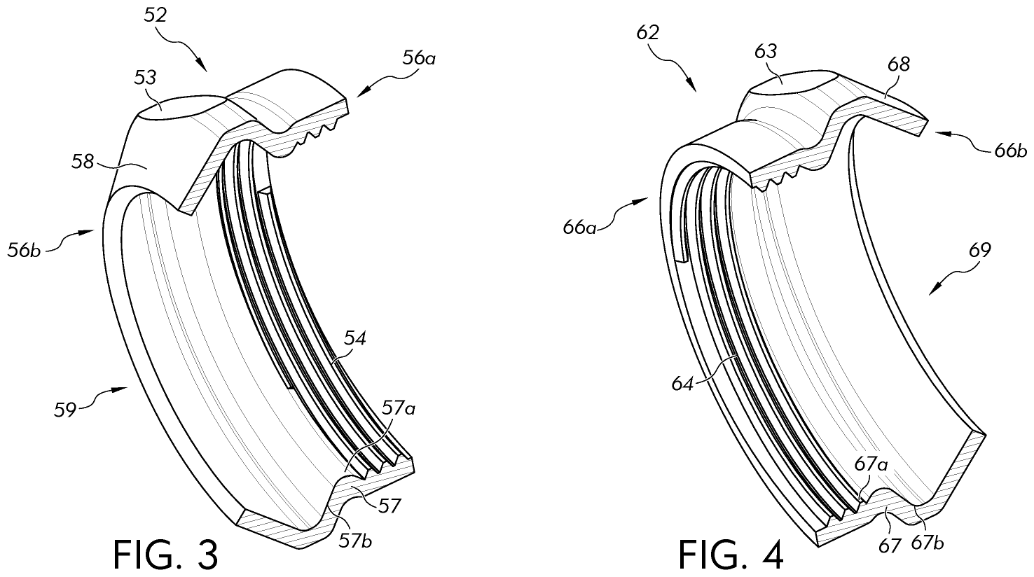

As shown in FIGS. 1 and 2, a compression coupling assembly 50 generally includes a first compression nut 52, a second compression nut 62, and a coupling body 72. The first compression nut 52 and the second compression nut 62 are configured to engage the coupling body 72 via threads. The first compression nut 52, the second compression nut 62, and the coupling body 72 are located along a longitudinal axis X.

Referring to FIG. 3, the first compression nut 52 is tubular-shaped with a first end portion 56a and a second end portion 56b. A thread 54 is formed on an inner surface of the first compression nut 52 at the first end portion 56a. A protrusion 57 on the inner surface of the first compression nut 52 protrudes radially inward and extends around the circumference of the first compression nut 52. The protrusion 57 is located adjacent to the thread 54. The protrusion 57 has a leading surface 57a and a trailing surface 57b located on the inner surface of the first compression nut 52. The leading surface 57a is formed to be sloped and is located adjacent to the thread 54. The trailing surface 57b is formed to be sloped away from the leading surface 57a.

The second end portion 56b of the first compression nut 52 is formed to define an inwardly sloped flange 58. The inwardly sloped flange 58 forms a boundary for a first opening 59 and is located adjacent to the trailing surface 57b. In the embodiment illustrated, the outer surface of the first compression nut 52 is generally smooth. However, flats 53 may be formed on the outer surface of the first compression nut 52 for allowing a user to grip the first compression nut 52 using a tool, such as a wrench, pliers, etc., so the first compression nut 52 may be rotated about the longitudinal axis X.

Referring to FIGS. 2 and 4, the second compression nut 62 is tubular-shaped with a first end portion 66a and a second end portion 66b. A thread 64 is formed on the inner surface of the second compression nut 62 at the first end portion 66a. A protrusion 67 on the inner surface of the second compression nut 62 protrudes radially inward and extends around the circumference of the second compression nut 62. The protrusion 67 is located adjacent to the thread 64. The protrusion 67 has a leading surface 67a and a trailing surface 67b located on the inner surface of the second compression nut 62. The leading surface 67a is formed to be sloped and is located adjacent to the thread 64. The trailing surface 67b is formed to be sloped away from the leading surface 67a.

The second end portion 66b of the second compression nut 62 is formed to define an inwardly sloped flange 68. The inwardly sloped flange 68 forms a boundary for a first opening 69 and is located adjacent to the trailing surface 67b. In the embodiment illustrated, the outer surface of the second compression nut 62 is generally smooth. However, flats 63 may be formed on the outer surface of the second compression nut 62 for allowing a user to grip the second compression nut 62 using a tool, such as a wrench, pliers, etc., so the second compression nut 62 may be rotated about the longitudinal axis X.

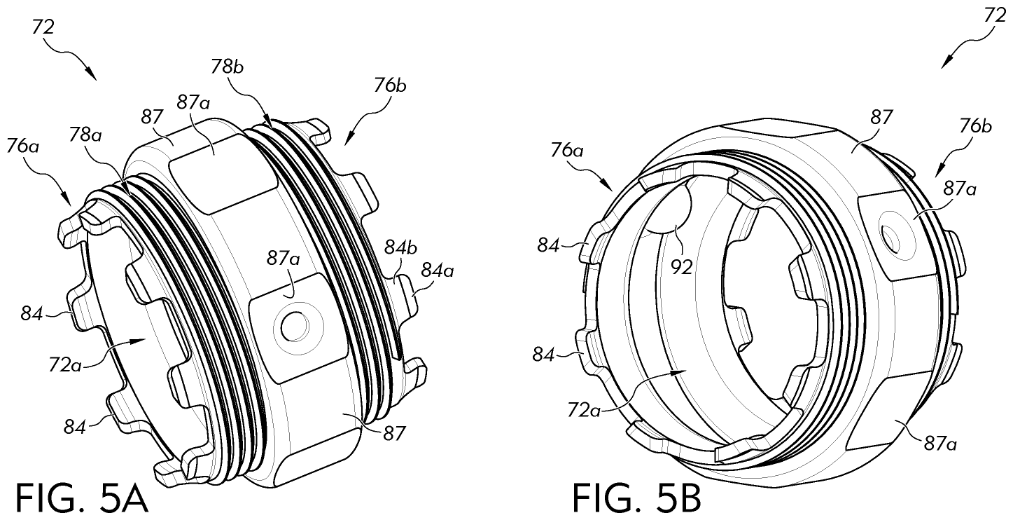

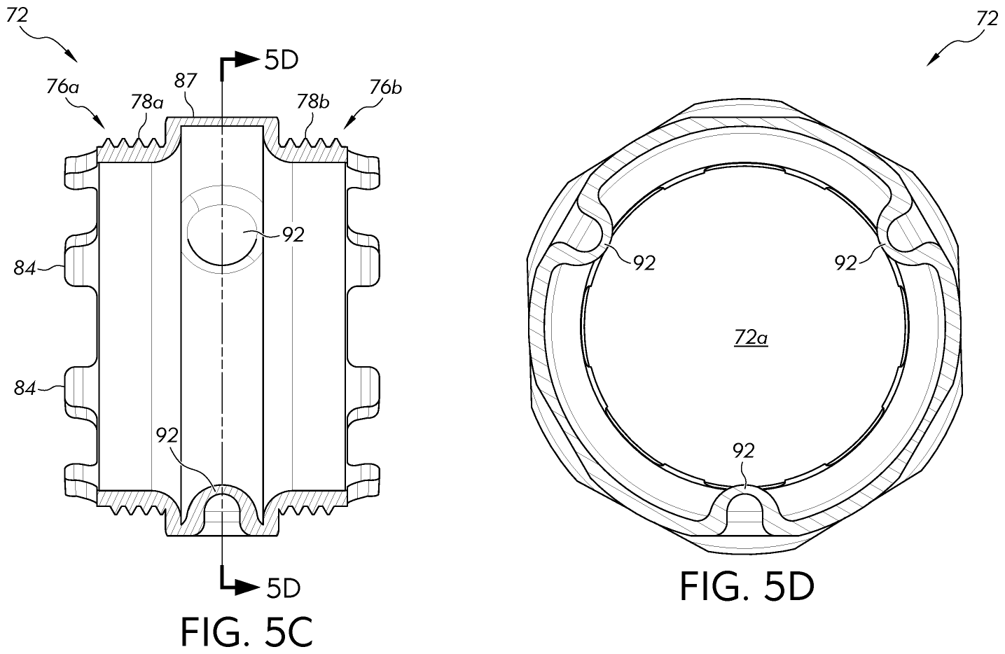

Referring to FIGS. 2 and 5A-5D, the coupling body 72 is generally tubular in shape and defines an inner cavity 72a located within. The coupling body 72 is formed to have a central portion 87, a first end portion 76a, and a second end portion 76b. The coupling body 72 includes a first thread 78a and a second thread 78b located at the first end portion 76a and the second end portion 76b, respectively.

A plurality of spaced-apart teeth 84 extend axially away from the first end portion 76a of the coupling body 72, and a plurality of spaced-apart teeth 84 extend axially away from the second end portion 76b of the coupling body 72. Each of the plurality of spaced-apart teeth 84 has a distal end portion 84a located furthest away from the central portion 87 of the coupling body 72 and a proximal portion 84b located between the distal end portion 84a and the central portion 87 of the coupling body 72.

The central portion 87 may include a plurality of flats 87a for allowing a user to grip the coupling body 72 using a tool, such as a wrench, pliers, etc., so the coupling body 72 may held in place while the first and second compression nuts 52, 62 are rotated about the longitudinal axis X.

Referring to FIGS. 5B-5D, at least one stop 92 is formed on the inner surface of the central portion 87 of the coupling body 72 and protrudes radially inward. It is contemplated that the coupling body 72 may have more than one stop 92, e.g., two, three, four or more, disposed at discrete locations about the inner surface of the central portion 87 of the coupling body 72. In the embodiment illustrated in FIGS. 5C and 5D, the stops 92 are formed on the inner surface of the central portion 87 of the coupling body 72 and are of a dome-shape. It is contemplated that the stops 92 may have other shapes, e.g., cuboid, cylindrical, conical, pyramidal, etc. The stops 92 are configured to limit a distance that a conduit may extend within the coupling body 72, as described in detail below.

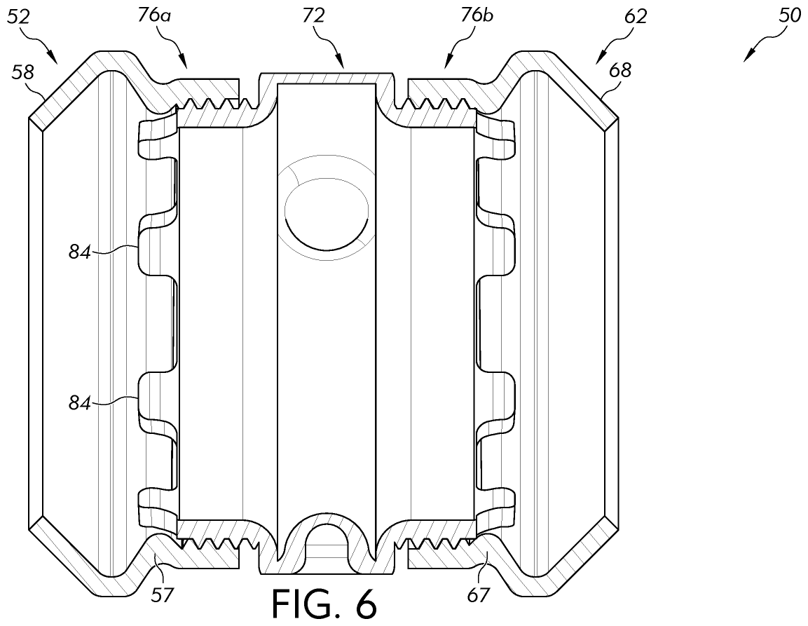

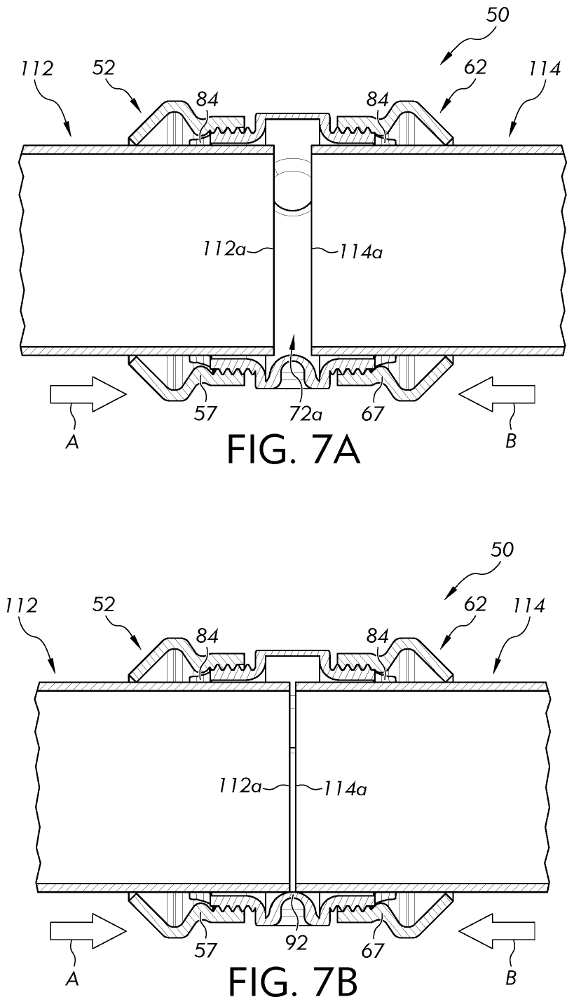

As seen in FIG. 6, the compression coupling assembly 50 may be assembled by threading the first compression nut 52 to the first end portion 76a of the coupling body 72 and threading the second compression nut 62 to the second end portion 76b of the coupling body 72 opposite the first compression nut 52. The spaced-apart teeth 84 extending away from the first end portion 76a of the coupling body 72 are located adjacent to the protrusion 57 of the first compression nut 52. The spaced-apart teeth 84 extending away from the second end portion 76b of the coupling body 72 are located adjacent to the protrusion 67 of the second compression nut 62.

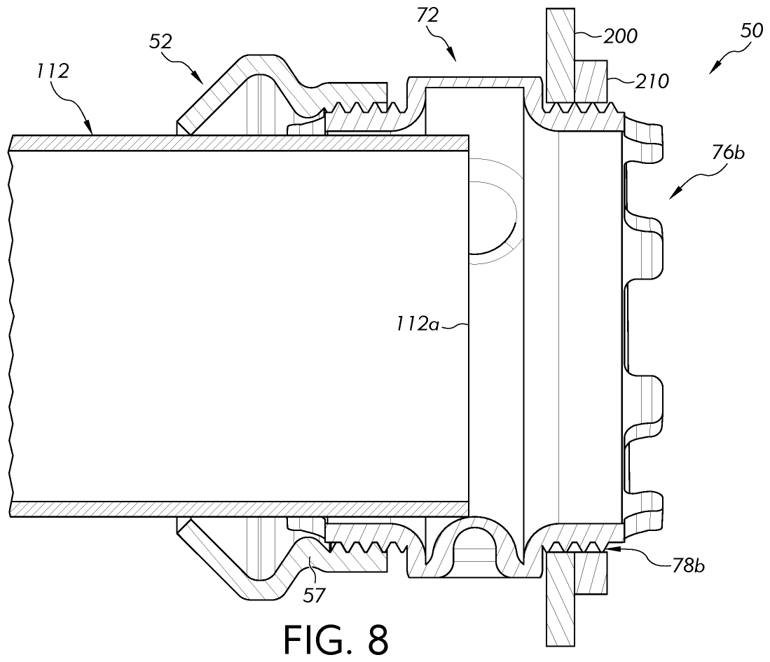

The present apparatus will now be described with relation to the attachment of one or more conduits thereto. Referring to FIG. 7A, a first conduit 112 is inserted (see arrow A) into the opening 59 (FIG. 3) at the first end portion 56a of the first compression nut 52 and into the compression coupling assembly 50. A distal end 112a of the first conduit 112 is then located within the inner cavity 72a of the coupling body 72. In this position, the spaced-apart teeth 84 near the first end 76a of the coupling body 72 provide clearance for the first conduit 112 to enter the compression coupling assembly 50. In an alternative embodiment, the spaced-apart teeth 84 define an opening that is smaller than an outer diameter of the conduit 112. When the conduit 112 is inserted into the first end 76a of the coupling body 72, the spaced-apart teeth 84 near the first end 76a of the coupling body 72 may be flexed radially outward to allow the distal end 112a of the first conduit 112 to be received within an inner cavity 72a of the coupling body 72.

Thereafter, a second conduit 114 is inserted (see arrow B) into the opening 69 (FIG. 4) at the first end portion 66a of the second compression nut 62 and into the compression coupling assembly 50. A distal end 114a of the second conduit 114 is then located within the inner cavity 72a of the coupling body 72. In this position, the spaced-apart teeth 84 near the second end 76b of the coupling body 72 provide clearance for the conduit 114 to enter the compression coupling assembly 50. In an alternative embodiment, the spaced-apart teeth 84 define an opening that is smaller than an outer diameter of the conduit 114. When the conduit 114 is inserted into the second end 76b of the coupling body 72, the spaced-apart teeth 84 near the second end 76b of the coupling body 72 may be flexed radially outward to allow the distal end 114a of the second conduit 114 to be received within the inner cavity 72a of the coupling body 72. As seen in FIG. 7B, the distal ends 112a, 114a of the first and second conduits 112, 114 are impeded from extending to the opposite side of the compression coupling assembly 50 by engaging with a protruding surface of the stop 92.

Thereafter, the first and second compression nuts 52, 62 are tightened. As the first compression nut 52 moves toward the coupling body 72, the leading surface 57a (FIG. 3) of the protrusion 57 is pressed against the proximal portion 84b (FIG. 5A) of the spaced-apart teeth 84 on the first end 76a of the coupling body 72. This pressing causes the spaced-apart teeth 84 to be compressed radially inward. The spaced-apart teeth 84, in turn, compress against an outer surface of the first conduits 112, thereby securing the compression coupling assembly 50 to the first conduit 112.

As the second compression nut 62 moves toward the coupling body 72, the leading surface 67a (FIG. 4) of the protrusion 67 of the second compression nut 62 is pressed against an outer surface of the proximal portion 84b (FIG. 5A) of the spaced-apart teeth 84 near the second end 76b of the coupling body 72. This pressing causes the spaced-apart teeth 84 near the second end 76b of the coupling body 72 to be compressed radially inward. The spaced-apart teeth 84, in turn, compress against an outer surface of the second conduit 114, thereby securing the compression coupling assembly to the second conduit 114.

In an alternative embodiment, as seen in FIG. 8, the compression coupling assembly 50 may utilize only the first compression nut 52. The second end 76b of the coupling body 72 is inserted into an electrical panel 200. The coupling body 72, and thus the compression coupling assembly 50, is secured to the electrical panel 200 via a nut 210. The nut 210 is located on the opposite side of the electrical panel 200 from the first compression nut 52 and is threaded onto the second thread 78b. The first conduit 112 is then inserted into the first compression nut 52 and thus into the compression coupling assembly 50.

It will be apparent to those skilled in the art that various modifications and variations can be made without departing from the spirit and scope of the claimed invention.

1. A compression coupling assembly for joining at least one conduit, the compression coupling assembly including:
a coupling body having an end portion and a central portion,
the end portion having a threaded portion on an outer surface of the coupling body, and
a plurality of spaced-apart teeth extending away from the threaded portion and the central portion, and
a compression nut,
the compression nut having an inner thread and a protrusion,
the inner thread being configured to engage with the threaded portion of the coupling body,
the protrusion having a leading surface that is configured to engage with the plurality of spaced-apart teeth,
the plurality of spaced-apart teeth being configured to compress an outer surface of a conduit.

2. The compression coupling assembly according to claim 1, wherein the coupling body has a second end portion located opposite the end portion.

3. The compression coupling assembly according to claim 2, wherein the second end portion includes a second threaded portion on the outer surface of the coupling body, the second end portion further including a plurality of spaced-apart teeth extending away from the second threaded portion and the central portion of the coupling body.

4. The compression coupling assembly according to claim 2, wherein the assembly includes a second compression nut, the second compression nut having an inner thread and a protrusion, the second compression nut being configured to engage the second threaded portion of the coupling body.

5. The compression coupling assembly according to claim 1, wherein the coupling body is attached to an electrical panel.

6. The compression coupling assembly according to claim 1, wherein the coupling body and the compression nut extend along a longitudinal axis.

7. The compression coupling assembly according to claim 1, wherein the plurality of spaced-apart teeth extend axially away from the threaded portion and the central portion.

8. The compression coupling assembly according to claim 1, wherein an outer surface of the compression nut includes a plurality of flats formed therein.

9. The compression coupling assembly according to claim 8, wherein the plurality of flats are formed within the central portion of the outer surface of the compression nut.

10. The compression coupling assembly according to claim 1, wherein at least one stop is formed on an inner surface of the central portion of the coupling body.

11. The compression coupling assembly according to claim 10, wherein the at least one stop protrudes radially inward.

12. The compression coupling assembly according to claim 10, wherein the at least one stop is configured to engage with the at least one conduit.

13. The compression coupling assembly according to claim 1, wherein the compression nut further includes an inwardly sloped flange and a trailing surface.

14. The compression coupling assembly according to claim 13, wherein the trailing surface is located between the inwardly sloped flange and the protrusion.

15. The compression coupling assembly according to claim 13, wherein the inwardly sloped flange forms a boundary for an opening.
